(19) United States
(12) Patent Application Publication
(10) Pub. No.: US 2004/0212981 A1
(43) Pub. Date: Oct. 28, 2004

(54) LED lighting module

(75) Inventors: Chien-Chang Wang, Changhua (TW); Hua-Nan Huang, Miaoli (TW)

Correspondence Address: QUINTERO LAW OFFICE, 1617 BROADWAY, 3RD FLOOR, SANTA MONICA, CA, 90404, US

(73) Assignee: Toppoly Optoelectronics Corp.

(21) Appl. No.: 10/424,466

(22) Filed: Apr. 28, 2003

(51) Int. Cl. F21V 7/04

(52) U.S. Cl. 362/31

(57) ABSTRACT

An LED lighting module. The LED lighting module comprises a light guiding plate and an LED. The light guiding plate has a first side, a second side adjacent to the first side, a light emitting surface in the central part of the light guiding plate, a depression disposed on the first side, and a reflecting portion disposed on the second side. The LED is disposed in the depression and inclined with respect to the first side, wherein the light emitted from the LED is reflected and guided to the light emitting surface by the reflecting portion.

### BACKGROUND OF THE INVENTION

1. Field of the Invention

The present invention relates to an LED (Light-Emitting Diode) lighting module, and in particular to an LED lighting module that provides uniform illumination by means of a curved reflecting portion that guides light from the inclined LEDs provided therein.

2. Description of the Related Art

With the progress of semiconductor and flat panel display manufacturing technology, flat panel displays such as LCDs (Liquid Crystal Displays) have been applied to many electronic devices such as mobile telephones, digital cameras, and PDAs (Personal Digital Assistants).

In general, as shown in FIG. 1, the conventional lighting module of a flat panel display uses the LEDs 3 as light sources disposed beside the rectangular light guiding plate 1. The light emitting surface 2 is in the central part of the light guiding plate 1. Thus, light emitted from the LEDs 3 enters the light guiding plate 1 forming a planar light source by deflection in the region of the light emitting surface 2.

As the light emitting angle θ of the LEDs 3 are limited, the light hardly covers the entire area of the light emitting surface 2. Thus, the dark zones Z usually occur such that the flat panel display cannot have uniform illumination.

Referring to the conventional lighting module with a light guiding rod 4 as shown in FIG. 2, the arrows indicate the direction of light rays emitted from the LEDs 3. To address the disadvantage mentioned above, a light guiding rod 4 is provided opposite to one side of the light guiding plate 1 and the LEDs 3 are disposed beside the light guiding rod 4 as light sources. The light guiding rod 4 has a reflecting surface 41 with a plurality of tiny V-cut structures (not shown) therein. Thus, the light rays emitted from the LEDs 3 are reflected by the reflecting surface 41 then reach the light emitting surface 2.

The conventional LED lighting module as shown in FIG. 2 can avoid the dark zones Z. However, the orientation and position of the LEDs 3 are seriously restricted such that the light cannot be distributed uniformly within the light emitting surface 2 due to the difference in distance from the light emitting surface 2 to the LEDs 3.

### SUMMARY OF THE INVENTION

An object of the invention is to provide an LED lighting module capable of delivering uniform illumination by guiding light from the inclined LEDs.

The LED lighting module comprises a light guiding plate and an LED. The light guiding plate has a first side, a second side adjacent to the first side, a light emitting surface in the central part of the light guiding plate, a depression disposed on the first side, and a reflecting portion disposed on the second side. The LED is disposed in the depression and inclined in respect to the first side, wherein the light emitted from the LED is reflected and guided to the light emitting surface by the reflecting portion.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective diagram of a conventional lighting module of a flat panel display;

FIG. 2 is a perspective diagram of a conventional lighting module with a light guiding rod;

FIG. 3a is a perspective diagram of the LED lighting module in accordance with the present invention;

FIG. 3b is a perspective diagram of another preferred embodiment in accordance with the present invention;

FIG. 4a is a perspective diagram in large view of portion A as shown in FIG. 3a;

FIG. 4b is a perspective diagram of another preferred embodiment of portion A in FIG. 3a of the present invention;

FIG. 4c is a perspective diagram of another preferred embodiment of portion A in FIG. 3a of the present invention;

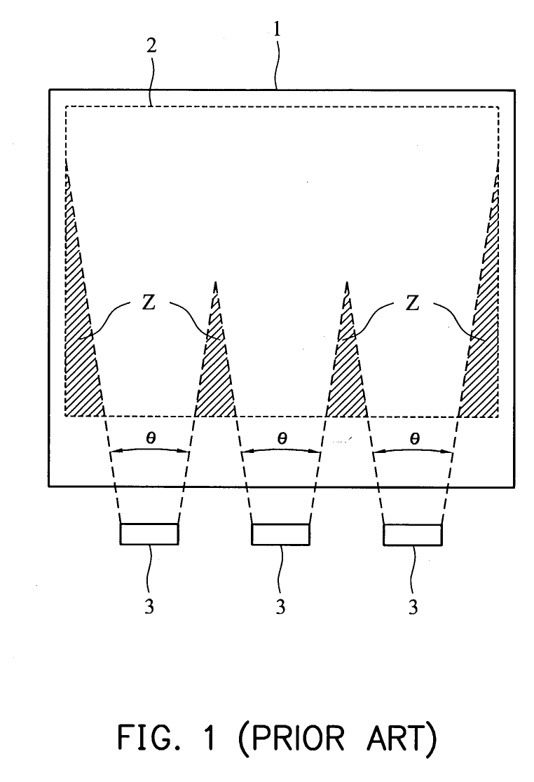

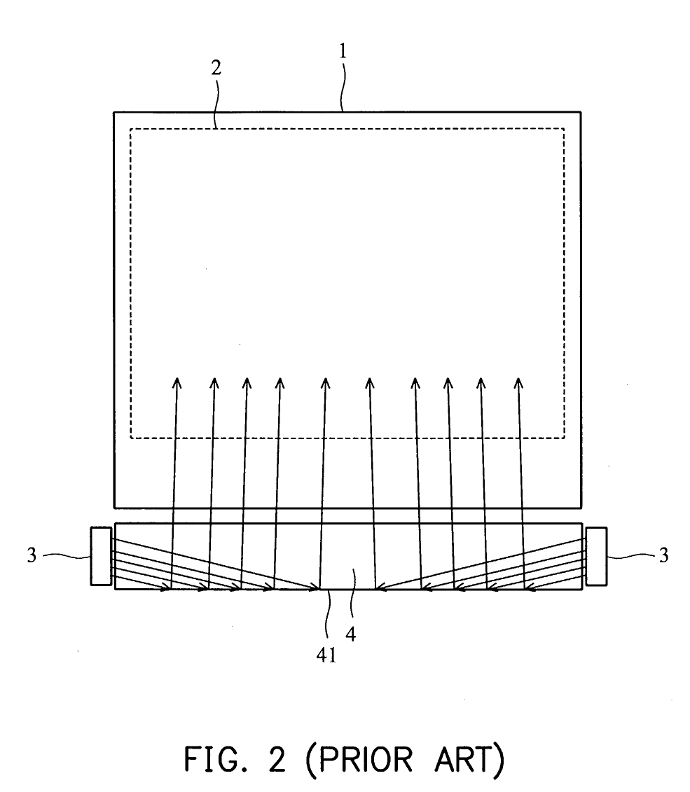

### DETAILED DESCRIPTION OF THE INVENTION

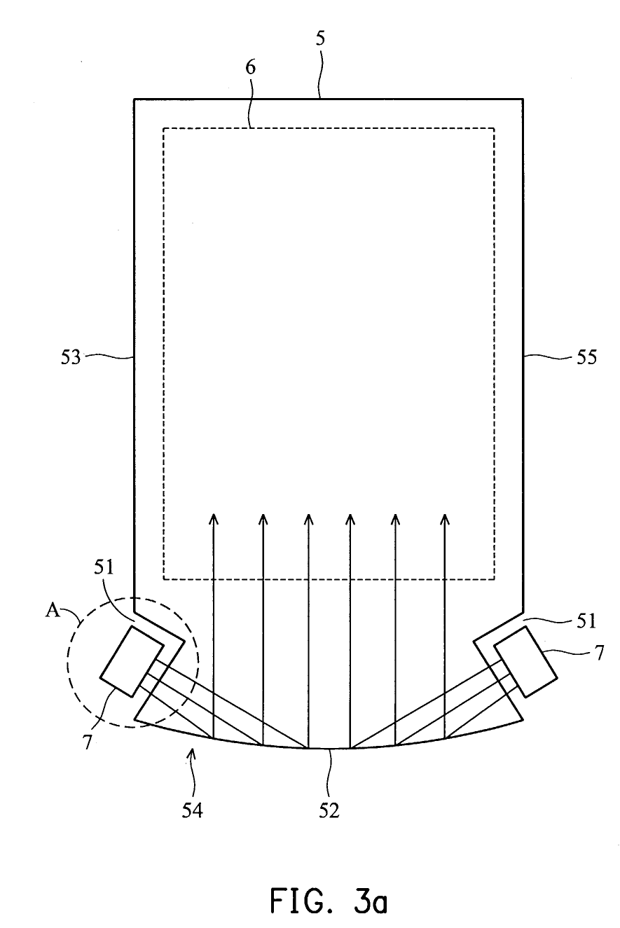

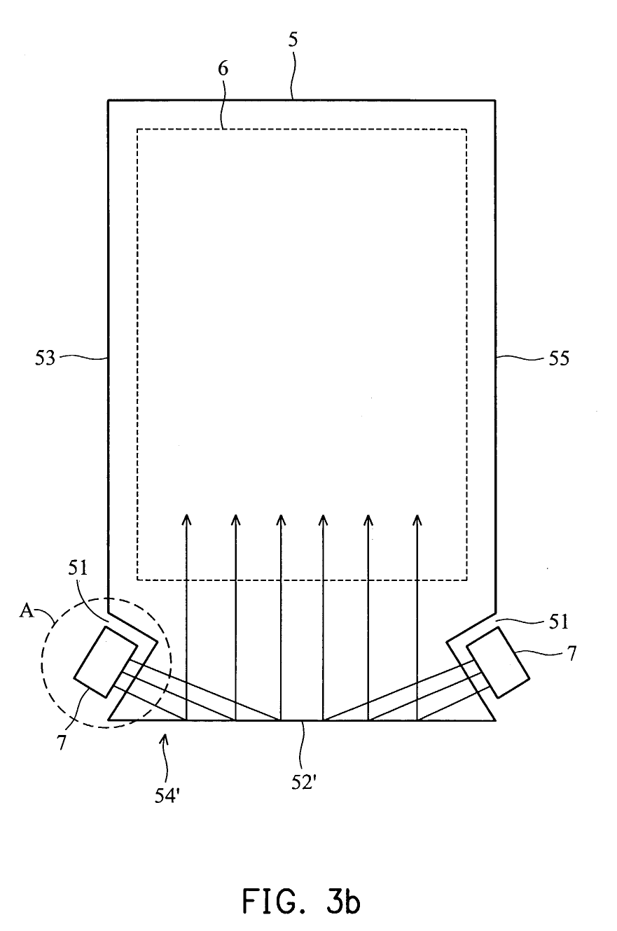

Referring to FIG. 3a, the LED lighting module of the present invention has a light guiding plate 5 and a light emitting surface 6 in the central part thereof. To provide the required illumination of the flat panel display, light is emitted from the LEDs 7 and guided to the light emitting surface 6. The light guiding plate 5 has a first side 53, a second side 54 adjacent to the first side 53, and a third side 55 opposite to the first side 53. In FIG. 3a, the first side 53 and the third side 55 both have a depression 51 located near the end thereof adjacent to the second side 54. The LEDs 7 are disposed in the depressions 51 individually. Thus, as shown in FIG. 3a, the light rays emitted from the LEDs 7 are reflected by the reflecting portion 52 in the second side 54 then reach the light emitting surface 6.

FIG. 3b is a perspective diagram of another preferred embodiment in accordance with the present invention. In FIG. 3b, the second side 54 of the light guiding plate 5 is straight, and the LEDs 7 are inclined in respect to the first side 53 and the third side 55 such that the light reflected via the second side 54 increases. To reflect light uniformly, the second side 54 in particular, has a reflecting portion 52′ with a plurality of rugged portions (not shown) such as the conventional tiny V-cut structures.

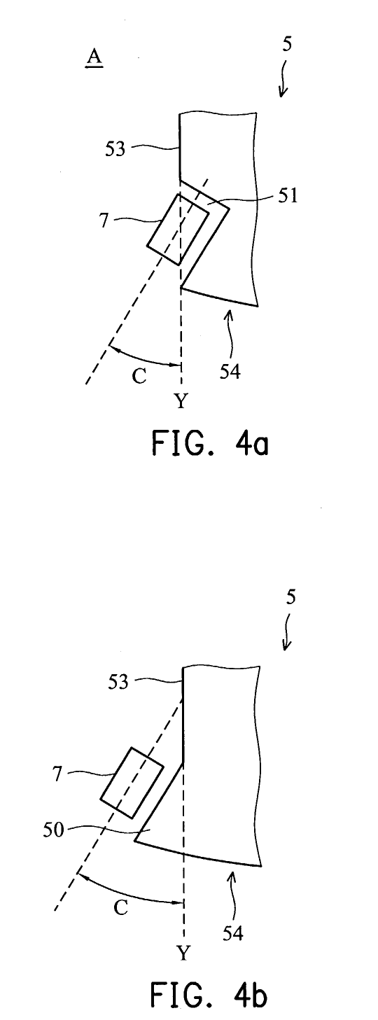

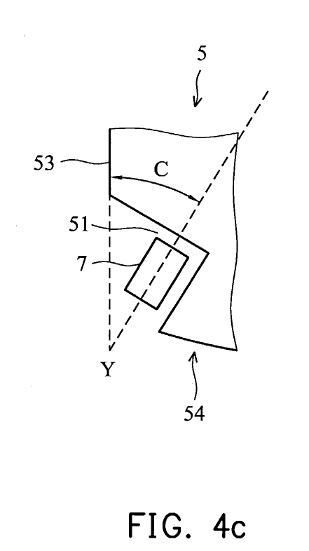

FIG. 4a is a perspective diagram in large view of portion A as shown in FIG. 3a. The depression 51 is located near the end of the first side 53 adjacent to the second side 54, and the LED 7 is disposed in the depression 51. As shown in FIG. 4a, the extending line Y of the first side 53 passes through the LED 7, wherein the LED 7 is inclined in respect to the first side 53 at an angle C between 0° to 45°.

Moreover, regarding considerations of light intensity and formality, the position and orientation of the LED 7 are also adjustable. FIG. 4b shows another preferred embodiment of portion A in FIG. 3a. As shown in FIG. 4b, the protrusion 50 is disposed near the end of the first side 53 adjacent to the second side 54, and the LED 7 is disposed opposite to the protrusion 50. Particularly, the LED 7 is outside the extending line Y of the first side 53 and inclined in respect to the first side 53 at an angle C between 0° to 45°.

As another preferred embodiment shows in FIG. 4c, the depression 51 with larger area is located near the end of the first side 53 adjacent to the second side 54, and the LED 7 is disposed in the depression 51. Particularly, the LED 7 is inside the extending line Y of the first side 53 and inclined in respect to the first side 53 at an angle C between 0° to 45°.

Thus, the present invention provides an LED lighting module using a light guiding plate 5 with the curved reflecting portion 52 to guide light from the LEDs 7 to the light emitting surface 6. The present invention has not only the function of a conventional light guiding rod but also simplifies the assembly process. Additionally, as the LEDs 7 are seated in the depressions 51 and inclined in respect to the first side 53 and the third side 5, the light from the LEDs 7 can be efficiently projected on the second side 54. As mentioned above, the present invention can avoid conventional dark zones, and increase the intensity of reflected light and illumination uniformity.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art) Therefore, the scope of the appended claims should be accorded the broadest interpretation so as to encompass all such modifications and similar arrangements.

What is claimed is:

1. An LED lighting module, comprising:
a light guiding plate, having a first side, a second side adjacent to the first side, a light emitting surface in the central part of the light guiding plate, a depression disposed on the first side and a reflecting portion disposed on the second side;
an LED disposed in the depression and inclined in respect to the first side, wherein the light emitted from the LED is reflected and guided to the light emitting surface by the reflecting portion.

2. The LED lighting module as claimed in claim 1, wherein the second side is curved.

3. The lighting module as claimed in claim 1, wherein the LED is inclined in respect to the first side at an angle between 0° to 45°.

4. The LED lighting module as claimed in claim 1, wherein the LED is located on the extending line of the first side.

5. The LED lighting module as claimed in claim 1, wherein the LED is located inside the extending line of the first side.

6. The LED lighting module as claimed in claim 1, wherein the depression is located near the end of the first side adjacent to the second side.

7. The LED lighting module as claimed in claim 1, wherein the second side has a plurality of rugged portions.

8. The LED lighting module as claimed in claim 7, wherein the rugged portions are V-cut structures.

9. An LED lighting module, comprising:
a light guiding plate, having a first side, a second side adjacent to the first side, a light emitting surface in the central part of the light guiding plate, a protrusion disposed on the first side and a reflecting portion disposed on the second side;
an LED opposite to the protrusion and inclined with respect to the first side, wherein the light emitted from the LED is reflected and guided to the light emitting surface by the reflecting portion.

10. The LED lighting module as claimed in claim 9, wherein the second side is curved.

11. The LED lighting module as claimed in claim 9, wherein the LED is located outside the extending line of the first side.

12. The LED lighting module as claimed in claim 9, wherein the LED is inclined with respect to the first side at an angle between 0° to 45°.

13. The LED lighting module as claimed in claim 9, wherein the depression is located near the end of the first side adjacent to the second side.

14. The LED lighting module as claimed in claim 9, wherein the second side has a plurality of rugged portions.

15. The LED lighting module as claimed in claim 14, wherein the rugged portions are V-cut structures.
